(19) United States
(12) Patent Application Publication
(10) Pub. No.: US 2005/0124518 A1
(43) Pub. Date: Jun. 9, 2005

(54) Substrate treating apparatus

(75) Inventors: Hiroaki Sugimoto, Kyoto (JP); Seiichiro Okuda, Kyoto (JP); Takuya Kuroda, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/037,521

(22) Filed: Jan. 18, 2005

Related U.S. Application Data
(62) Division of application No. 10/307,152, filed on Nov. 27, 2002.

(30) Foreign Application Priority Data
Dec. 7, 2001 (JP) 2001-373586
Oct. 21, 2002 (JP) 2002-305200

(51) Int. Cl. C11D 1/00

(52) U.S. Cl. 510/212

(57) ABSTRACT

A substrate treating apparatus includes a cleaning medium feed mechanism having a discharge nozzle for discharging warm water as a cleaning medium toward a substrate. The discharge nozzle is reciprocable between a position opposed to the center of rotation of the substrate held and rotated by a spin chuck and a position opposed to the edge of the substrate. The discharge nozzle is connected to a deionized water source through a solenoid valve and a heater. Deionized water fed from the deionized water source is heated warm and supplied to the substrate through the discharge nozzle.

### BACKGROUND OF THE INVENTION

1. Field of the Invention

The present invention relates to a substrate treating apparatus for removing organic substances such as a reaction product from substrates by using an organic substance remover.

2. Description of the Related Art

In manufacture of semiconductor devices, an etching process is carried out to make a pattern, by using a resist film as a mask, from a film of metal such as aluminum, copper or the like formed on the surface of a substrate, e.g. a semiconductor wafer. For forming a microcircuit pattern in the etching process, dry etching such as RIE (Reactive Ion Etching) is employed.

Reactive ions used in dry etching have such strong power as to resolve the resist film to some extent before the etching of the metal film is completed. Part of the resist film changes into a reaction product such as a polymer, and deposits on side walls of the metal film. This reaction product cannot be removed in a resist removing process to follow. It is therefore necessary to remove the reaction product before carrying out the resist removing process.

Under such circumstances, it has been conventional practice to carry out a reaction product removing process after the dry etching process, to supply the substrate with a remover capable of removing the reaction product. After removing the reaction product from the side walls of the metal film in this way, the substrate is cleaned with deionized water, then the water is scattered and the substrate dried to complete the removal of the reaction product.

With increasingly fine patterns and changes in preliminary processes of late years, organic substances such as the reaction product adhering to the substrate now have diverse properties. This poses a problem that the conventional removing process requires a long time for removing the organic substances. Consequently, a substrate treating apparatus for performing the removing process includes a physical cleaning mechanism using a brush or ultrasonic vibration in addition to the function to clean substrates with deionized water.

However, where the physical cleaning mechanism is provided besides the deionized water cleaning function, the apparatus is enlarged and the cost thereof increased. Further, the need for a separate physical cleaning process in addition to the deionized water cleaning results in an extended time for treating substrates.

### SUMMARY OF THE INVENTION

The object of this invention, therefore, is to provide a substrate treating apparatus simple in construction and yet capable of completing removal of organic substances in a short time.

The above object is fulfilled, according to the present invention, by a substrate treating apparatus for removing organic substances from a surface of a substrate by using a remover, comprising a spin-support device for rotatably holding the substrate, a remover feed mechanism for supplying the remover toward the substrate of the surface held by the spin-support device, and a deionized water feed mechanism for supplying deionized water with an enhanced remover cleaning capability toward the surface of the substrate held by the spin-support device and having the remover supplied by the remover feed mechanism.

This substrate treating apparatus is simple in construction, and yet is capable of completing removal of the organic substances in a short time.

In another aspect of the invention, there is provided a substrate treating apparatus for removing organic substances from a surface of a substrate by using a remover, comprising a spin-support device for rotatably holding the substrate, a remover feed mechanism for supplying the remover toward the substrate of the surface held by the spin-support device, and a gas feed mechanism for supplying a gas toward the surface of the substrate held by the spin-support device and having the remover supplied by the remover feed mechanism.

In a further aspect of the invention, there is provided a substrate treating apparatus for removing organic substances from a surface of a substrate by using a remover, comprising a spin-support device for rotatably holding the substrate, a remover feed mechanism for supplying the remover toward the substrate of the surface held by the spin-support device, and a solid feed mechanism for supplying small pieces of a solid toward the surface of the substrate held by the spin-support device and having the remover supplied by the remover feed mechanism.

Other features and advantages of the present invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic plan view of a substrate treating apparatus according to the invention:,

FIG. 2 is a schematic side view of the substrate treating apparatus;

FIG. 3 is another schematic side view of the substrate treating apparatus;

FIG. 4 is a flow chart showing a substrate treating operation of the substrate treating apparatus;

FIG. 5 is a schematic side view of a substrate treating apparatus in a second embodiment of the invention;

FIG. 6 is a schematic side view of a substrate treating apparatus in a third embodiment of the invention;

FIG. 7 is a schematic side view of a substrate treating apparatus in a fourth embodiment of the invention;

FIG. 8 is a schematic side view of a substrate treating apparatus in a fifth embodiment of the invention; and

FIG. 9 is a schematic side view of a substrate treating apparatus in a sixth embodiment of the invention.

### DESCRIPTION OF THE PREFERRED EMBODIMENTS

The construction of a substrate treating apparatus according to the invention will be described hereinafter. This substrate treating apparatus is designed for removing a polymer as a reaction product from the surface of a substrate, e.g. a silicon semiconductor wafer, with a film formed thereon.

The film noted above is, for example, a film of metal such as copper, aluminum, titanium, tungsten, or a mixture thereof, or an insulating film such as a silicon oxide film, a silicon nitride film, an organic insulating film or a low dielectric layer insulating film. The film here includes a film having a height greater than a length of the bottom thereof, as well as a film with a height smaller than the length of the bottom thereof, when sectioned in a direction perpendicular to the principal surface of the substrate having the film formed thereon. Thus, the film includes those films and wiring formed on parts of the substrate, which are present in the form of lines or islands in plan view of the principal surface of the substrate.

Removers usable with this substrate treating apparatus include a solution containing an organic alkali such as DMF (dimethylformamide), DMSO (dimethyl sulfoxide) or hydroxylamine, a solution containing an organic amine, a solution containing an inorganic acid such as hydrofluoric acid, phosphoric acid or the like, and a solution containing an ammonium fluoride substance. Other usable removers include solutions containing 1-methyl-2-pyrrolidone, tetrahydrothiophene-1.1-dioxide, isopropanolamine, monoethanolamine, 2-(2-aminoethoxy)ethanol, catechol, N-methylpirrol-idone, aromatic diol, perchloroetylene or phenol. More particularly, the apparatus may use a mixed solution of 1-methyl-2-pyrrolidone, tetrahydrothiophene-1.1-dioxide and isopropanolamine, a mixed solution of dimethylsulfoxide and monoethanolamine, a mixed solution of 2-(2-aminoethoxy) ethanol, hydroxyamine and catechol, a mixed solution of 2-(2-aminoethoxy) ethanol and N-methylpirrolidone, a mixed solution of monoethanolamine, water and aromatic diol, and a mixed solution of perchloroethylene and phenol.

The solution containing an organic amine (called an organic amine-based remover) may be a mixed solution of monoethanolamine, water and aromatic triol, a mixed solution of 2-(2-aminoethoxy) ethanol, hydroxyamine and catechol, a mixed solution of alkanolamine, water, dialkylsulfoxide, hydroxyamine and an amine-based anticorrosive, a mixed solution of alkanolamine, glycol ether and water, a mixed solution of dimethylsulfoxide, hydroxyamine, triethylene-tetramine, pyrocatechol and water, a mixed solution of water, hydroxyamine and pyrogallol, a mixed solution of 2-amino-ethanol, ether and sugar alcohol, or a mixed solution of 2-(2-aminoethoxy) ethanol, N,N-dimethylacetamide, water and triethanolamine.

The solution containing an ammonium fluoride substance (called an ammonium fluoride remover) may be a mixed solution of an organic alkali, sugar alcohol and water, a mixed solution of a fluorine compound, an organic carboxylic acid and an acid/amide-based solvent, a mixed solution of alkylamide, water and ammonium fluoride, a mixed solution of dimethylsulfoxide, 2-aminoethanol, an aqueous solution of an organic alkali and aromatic hydrocarbon, a mixed solution of dimethylsulfoxide, ammonium fluoride and water, a mixed solution of ammonium fluoride, triethanolamine, pentamethyldiethylene triamine, iminodiacetate and water, a mixed solution of glycol, alkyl sulfate, organic salt, organic acid and inorganic salt, or a mixed solution of amide, organic salt, organic acid and inorganic salt.

Further, an inorganic remover containing an inorganic substance may be a mixed solution of water and a phosphoric acid derivative.

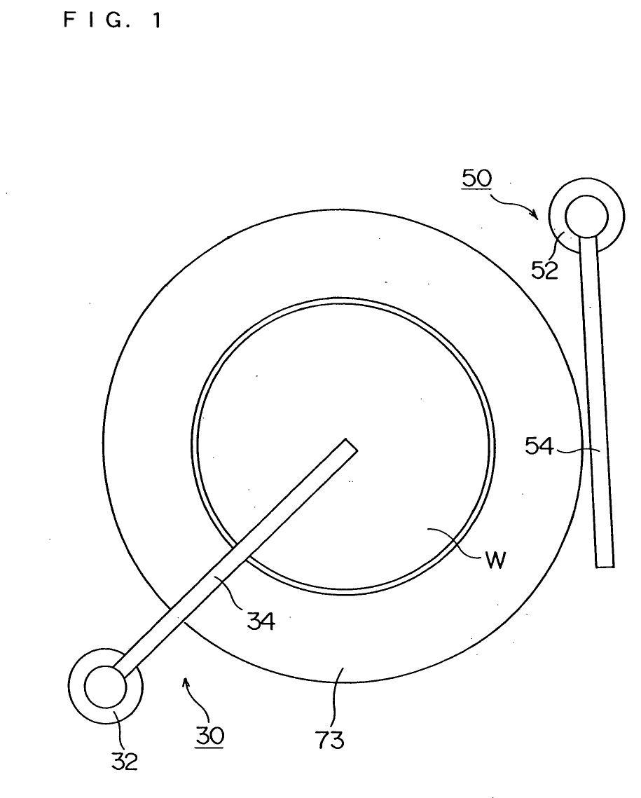

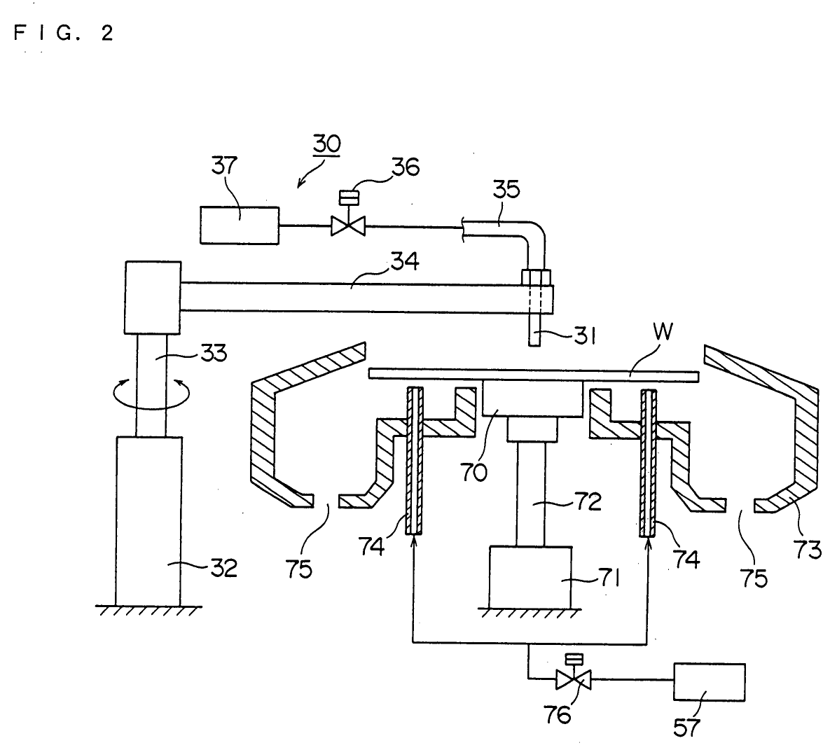

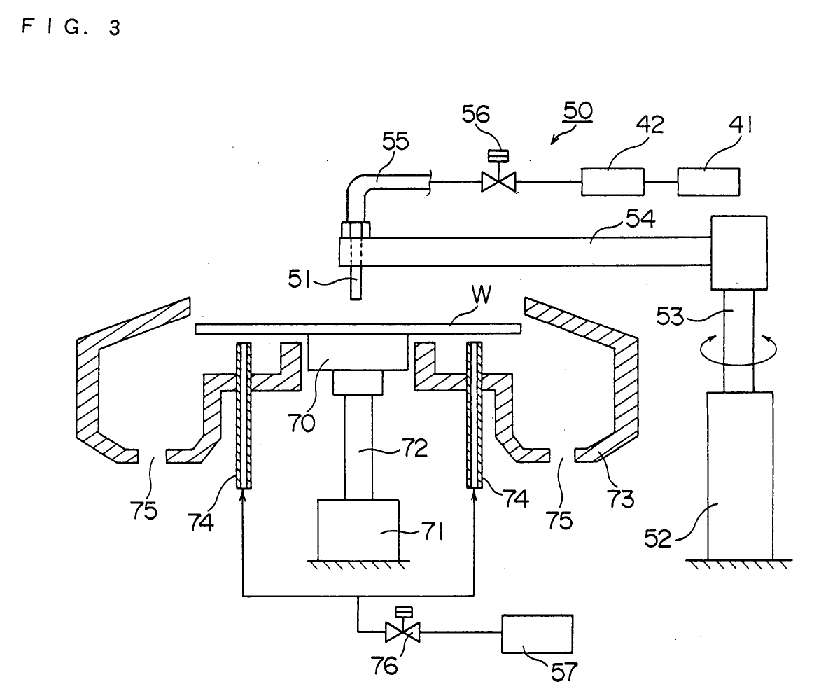

FIG. 1 is a schematic plan view of the substrate treating apparatus according to this invention. FIGS. 2 and 3 are schematic side views of the substrate treating apparatus, respectively. FIG. 2 shows a relationship between a remover feed mechanism 30, a spin chuck 70 and a scatter preventive cup 73. FIG. 3 shows a relationship between a cleaning medium feed mechanism 50, the spin chuck 70 and the scatter preventive cup 73. In these figures, the scatter preventive cup 73 and a back surface cleaning nozzle 74 are shown in section.

This substrate treating apparatus has the spin chuck 70 for rotatably holding a wafer W, the remover feed mechanism 30 for feeding a remover toward the surface of wafer W rotatably held by the spin chuck 70, and the cleaning medium feed mechanism 50 for feeding warm water as a cleaning medium toward the surface of wafer W held by the spin chuck 70.

As shown in FIGS. 2 and 3, the spin chuck 70, while holding the wafer W by suction, is driven by a motor 71 to rotate about a vertical support shaft 72. Thus, the wafer W spins with the spin chuck 70 in a plane parallel to the principal surface of wafer W.

The scatter preventive cup 73 is disposed around the spin chuck 70. The scatter preventive cup 73 is approximately channel-shaped in sectional view, while being approximately ring-shaped in plan view, defining a center opening. Further, the scatter preventive cup 73 has openings 75 formed in the bottom thereof and connected to a drain not shown.

The scatter preventive cup 73 includes back surface cleaning nozzles 74 arranged in positions opposed to the back surface of wafer W for cleaning the back surface by delivering a back surface cleaning liquid such as warm water or deionized water thereto. The back surface cleaning nozzles 74 are connected to a cleaning liquid source 57 through a solenoid valve 76. This back surface cleaning liquid source 57 is constructed for transmitting the cleaning liquid such as warm water or deionized water under pressure.

As shown in FIG. 2, the remover feed mechanism 30 includes a discharge nozzle 31 for discharging the remover toward the wafer W. This discharge nozzle 31 is mounted at a distal end of an arm 34 driven by a nozzle moving mechanism 32 to swing about a vertical shaft 33. Thus, the discharge nozzle 31 is reciprocable between a position opposed to the center of rotation of the wafer W held by the spin chuck 70, and a position opposed to the edge of the wafer W. The nozzle moving mechanism 32 is constructed for moving the arm 34 vertically also.

The discharge nozzle 31 is connected to a remover source 37 through a solenoid valve 36. The remover source 37 is constructed for transmitting, under pressure, the remover heated to a predetermined temperature. Numeral 35 denotes a tube for feeding the remover.

As shown in FIG. 3, the cleaning medium feed mechanism 50 includes a discharge nozzle 51 for discharging warm water as a cleaning medium toward the wafer W. This discharge nozzle 51 is mounted at a distal end of an arm 54 driven by a nozzle moving mechanism 52 to swing about a vertical shaft 53. Thus, the discharge nozzle 51 is reciprocable between a position opposed to the center of rotation of the wafer W held by the spin chuck 70, and a position opposed to the edge of the wafer W. The nozzle moving mechanism 52 is constructed for moving the arm 54 vertically also.

The discharge nozzle 51 is connected to a deionized water source 41 through a solenoid valve 56 and a heater 42. The deionized water fed from the deionized water source 41 is heated warm by the heater 42 to be delivered to the wafer W through the discharge nozzle 51. Numeral 55 denotes a tube for feeding the warm water.

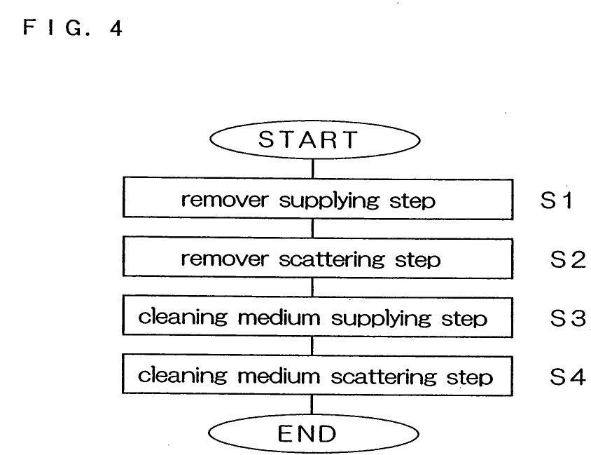

Next, a treating operation of the above substrate treating apparatus for removing a reaction product from the wafer W will be described. FIG. 4 is a flow chart showing the operation of the substrate treating apparatus according to this invention for treating the wafer W.

When this substrate treating apparatus is used to remove a reaction product generated on the surface of wafer W after a film formed thereon is patterned by dry etching using a resist film as a mask, a remover supplying step is carried out first (Step Si). In this remover supplying step, the wafer W held by the spin chuck 70 is rotated at low speed. Driven by the nozzle moving mechanism 32 of the remover feed mechanism 30, the discharge nozzle 31 moves back and forth between the position opposed to the center of rotation of the wafer W held by the spin chuck 70 and the position opposed to the edge of the wafer W. At this time, the solenoid valve 36 is opened to discharge the remover from the discharge nozzle 31. Thus, the remover is supplied over the entire surface of the wafer W rotating with the spin chuck 70. This remover supplying step removes the reaction product generated on the surface of the wafer W.

Next, a remover scattering step is carried out to scatter and discard the remover from the wafer W by spinning the wafer W at high speed (Step S2). In this remover scattering step, the wafer W is spun at a speed of 500 rpm or more, preferably 1,000 rpm to 4,000 rpm.

The remover scattering step is carried out immediately after the remover supplying step for the following reason. Where, for example, a remover containing an organic alkali solution is used, the remover remaining on the wafer W and mixing with the warm water (deionized water) would cause a phenomenon called “PH shock”, producing a strong alkali to damage metal wiring. It is therefore impossible to carry out successively the remover supplying step described above and a cleaning medium supplying step using deionized water as described hereinafter. Thus, it is necessary to remove the remover first from the wafer W using a large quantity of intermediate rinsing liquid after completion of the remover supplying step, and then carry out the cleaning medium supplying step for supplying deionized water to the wafer W. This results in an extended time taken by the intermediate rinsing liquid supplying step, and in consumption of the large quantity of intermediate rinsing water, which poses a problem of cost increase.

In this embodiment, however, the remover scattering lo step is carried out immediately after the remover supplying step. This eliminates the need for the intermediate rinsing step described above. Even where the intermediate rinsing step is carried out, this step may be completed within a short time using only a small quantity of intermediate rinsing liquid.

After completion of the remover scattering step, the cleaning medium supplying step is carried out (Step S3). In this cleaning medium supplying step, the wafer W is held and rotated at low speed by the spin chuck 70. Driven by the nozzle moving mechanism 52 of the cleaning medium feed mechanism 50, the discharge nozzle 51 moves back and forth between the position opposed to the center of rotation of the wafer W held by the spin chuck 70 and the position opposed to the edge of the wafer W. At this time, the solenoid valve 56 is opened to discharge the warm water as the cleaning medium from the discharge nozzle 51. Thus, the warm water is supplied over the entire surface of the wafer W rotating with the spin chuck 70, to clean the surface of wafer W.

In this cleaning medium supplying step, warm water, which is deionized water with an enhanced cleaning capability for removers, is used as the cleaning medium. Where warm water with high activating power is used as the cleaning medium, the cleaning capability for organic substances is increased. Residues of the reaction product, swollen in the remover supplying step, may be stripped off efficiently in a short time. Further, by dispensing with the conventional cleaning step with deionized water, the cost of the apparatus may be reduced and the treating process expedited. The warm water temperature in this step preferably is 60° C. to 80° C.

In the remover supplying step (Step S1) and the cleaning medium supplying step (Step S3), the solenoid valve 76 is opened to supply a cleaning liquid such as warm water or deionized water through the back surface cleaning nozzle 74 to the back surface of the wafer W held and rotated by the spin chuck 70. This is effective to prevent the reaction product removed from the front surface of wafer W from drifting around and adhering to the back surface of wafer W.

Thereafter, the cleaning medium scattering step (Step S4) is carried out to scatter and discard the warm water and the like from the wafer W by spinning the wafer W at high speed. In this cleaning medium scattering step, the spin chuck 70 spins the wafer W at a speed of 500 rpm or more, preferably 1,000 rpm to 4,000 rpm.

The treatment of wafer W ends with completion of the steps described above.

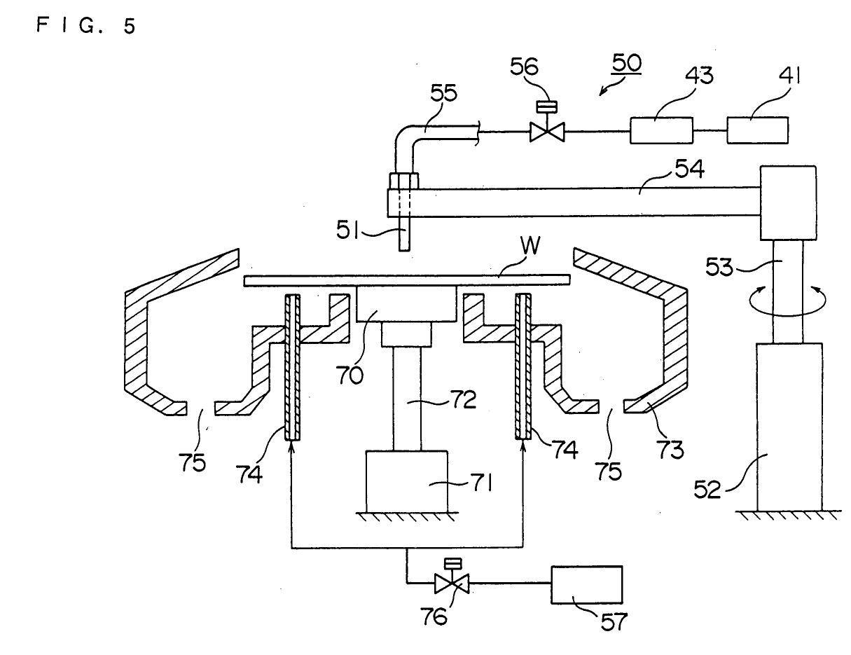

Another embodiment of the invention will be described next. FIG. 5 is a schematic side view of a substrate treating apparatus in the second embodiment of the invention. As does FIG. 3 described above, FIG. 5 shows a relationship between a cleaning medium feed mechanism 50, a spin chuck 70 and a scatter preventive cup 73. The construction and arrangement of a remover feed mechanism 30 and other components shown in FIGS. 1 and 2 are the same as in the first embodiment.

In the substrate treating apparatus according to the second embodiment, steam is supplied to the wafer W instead of the warm water in the first embodiment described above. In the following description, like reference numerals are used to identify like parts in the first embodiment and will not particularly be described again.

As shown in FIG. 5, the cleaning medium feed mechanism 50 in the second embodiment has a discharge nozzle 51 for discharging steam as a cleaning medium to the wafer W. This discharge nozzle 51, as in the first embodiment, is disposed at a distal end of an arm 54 driven by a nozzle moving mechanism 52 to swing about a vertical shaft 53. Thus, the discharge nozzle 51 is reciprocable between a position opposed to the center of rotation of the wafer W held by the spin chuck 70, and a position opposed to the edge of the wafer W. The nozzle moving mechanism 52 is constructed for moving the arm 54 vertically also.

The discharge nozzle 51 is connected to a deionized water source 41 through a solenoid valve 56 and a steamer 43. Deionized water fed from the deionized water source 41 is rapidly heated into steam, which is jetted from the discharge nozzle 51 to the wafer W. Numeral 55 denotes a tube for feeding the steam.

When the substrate treating apparatus in the second embodiment executes the cleaning medium supplying step (Step S3) in FIG. 4, the wafer W is held and rotated at low speed by the spin chuck 70. Driven by the nozzle moving mechanism 52 of the cleaning medium feed mechanism 50, the discharge nozzle 51 moves back and forth between the position opposed to the center of rotation of the wafer W held by the spin chuck 70 and the position opposed to the edge of the wafer W. At this time, the solenoid valve 56 is opened to discharge the steam as the cleaning medium from the discharge nozzle 51. Thus, the steam is supplied over the entire surface of the wafer W rotating with the spin chuck 70, to clean the surface of wafer W.

In the cleaning medium supplying step executed by the substrate treating apparatus in the second embodiment, steam, which is a gas, is used as the cleaning medium. Where steam with high activating power is used as the cleaning medium, the cleaning capability for organic substances is increased. Residues of the reaction product, swollen in the remover supplying step, may be stripped off efficiently in a short time. Further, by dispensing with the conventional cleaning step with deionized water, the cost of the apparatus may be reduced and the treating process expedited.

The steam here is water in gaseous state produced by heating deionized water. The steam includes minute water droplets. The droplets include those formed by condensation of water in gaseous state and those generated by applying ultrasonic radiation to deionized water in liquid state.

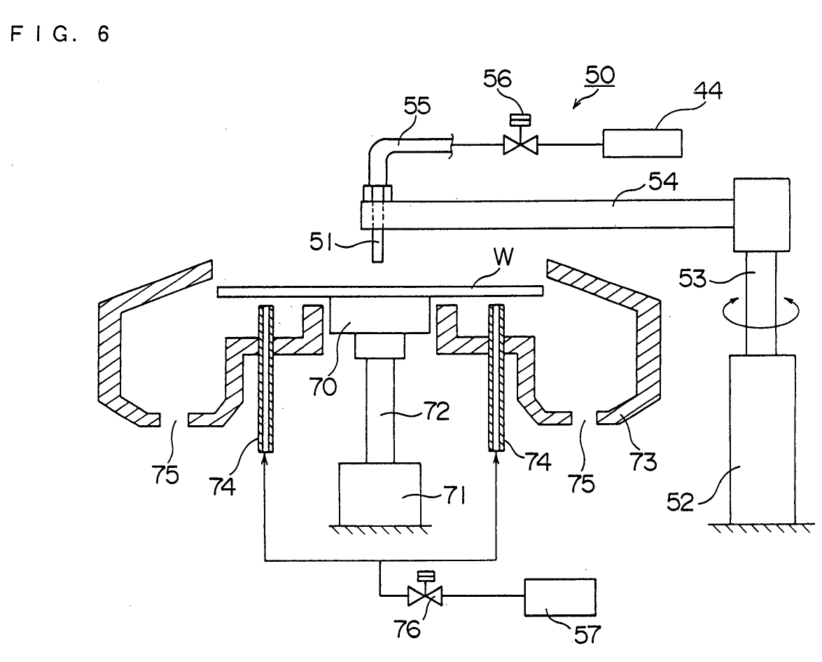

A further embodiment of the invention will be described. FIG. 6 is a schematic side view of a substrate treating apparatus in the third embodiment of the invention. As does FIG. 3 described above, FIG. 6 shows a relationship between a cleaning medium feed mechanism 50, a spin chuck 70 and a scatter preventive cup 73. The construction and arrangement of a remover feed mechanism 30 and other components shown in FIGS. 1 and 2 are the same as in the first embodiment.

In the substrate treating apparatus according to the third embodiment, carbon dioxide is supplied at high pressure to the wafer W instead of the warm water in the first embodiment described hereinbefore. In the following description, like reference numerals are used to identify like parts in the first embodiment and will not particularly be described again.

As shown in FIG. 6, the cleaning medium feed mechanism 50 in the third embodiment has a discharge nozzle 51 for discharging high-pressure carbon dioxide as a cleaning medium to the wafer W. This discharge nozzle 51, as in the first embodiment, is disposed at a distal end of an arm 54 driven by a nozzle moving mechanism 52 to swing about a vertical shaft 53. Thus, the discharge nozzle 51 is reciprocable between a position opposed to the center of rotation of the wafer W held by the spin chuck 70, and a position opposed to the edge of the wafer W. The nozzle moving mechanism 52 is constructed for moving the arm 54 vertically also.

The discharge nozzle 51 is connected to a carbon dioxide source 44 through a solenoid valve 56. Carbon dioxide supplied from the carbon dioxide source 44 is jetted from the discharge nozzle 51 to the wafer W. Numeral 55 denotes a tube for feeding the carbon dioxide.

When the substrate treating apparatus in the third embodiment executes the cleaning medium supplying step (Step S3) in FIG. 4, the wafer W is held and rotated at low speed by the spin chuck 70. Driven by the nozzle moving mechanism 52 of the cleaning medium feed mechanism 50, the discharge nozzle 51 moves back and forth between the position opposed to the center of rotation of the wafer W held by the spin chuck 70 and the position opposed to the edge of the wafer W. At this time, the solenoid valve 56 is opened to discharge the high-pressure carbon dioxide as the cleaning medium from the discharge nozzle 51. Thus, the high-pressure carbon dioxide is supplied over the entire surface of the wafer W rotating with the spin chuck 70, to clean the surface of wafer W.

In the cleaning medium supplying step executed by the substrate treating apparatus in the third embodiment, carbon dioxide, which is a gas, is used as the cleaning medium. The cleaning capability for organic substances is increased by using high-pressure carbon dioxide as a cleaning medium capable of increasing the cleaning capability for the wafer W without damaging the wafer W. Residues of the reaction product, swollen in the remover supplying step, may be stripped off efficiently in a short time. Further, by dispensing with the conventional cleaning step with deionized water, the cost of the apparatus may be reduced and the treating process expedited.

Other gases such as nitrogen gas may be used instead of carbon dioxide.

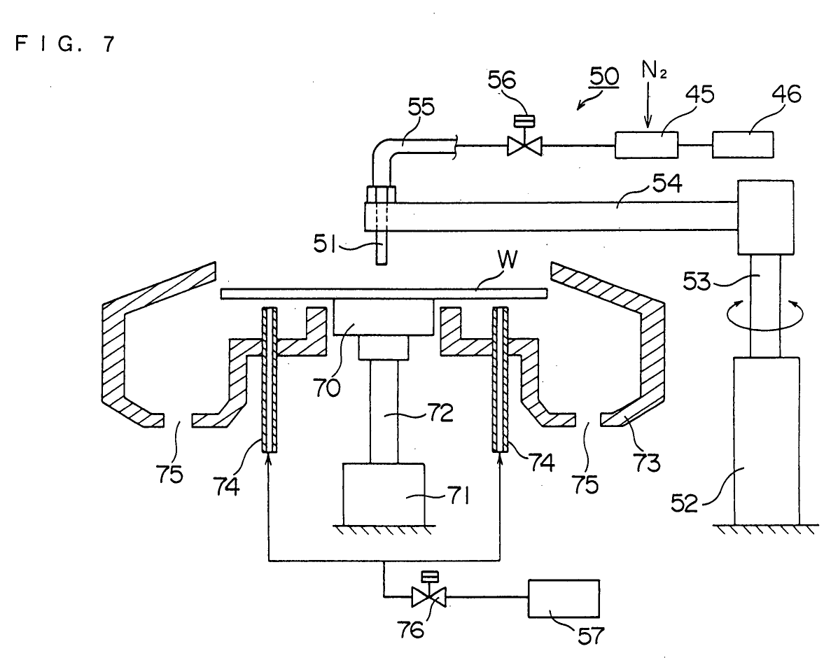

A further embodiment of the invention will be described. FIG. 7 is a schematic side view of a substrate treating apparatus in the fourth embodiment of the invention. As does FIG. 3 described above, FIG. 7 shows a relationship between a cleaning medium feed mechanism 50, a spin chuck 70 and a scatter preventive cup 73. The construction and arrangement of a remover feed mechanism 30 and other components shown in FIGS. 1 and 2 are the same as in the first embodiment.

In the substrate treating apparatus according to the fourth embodiment, small pieces of ice are supplied to the wafer W instead of the warm water in the first embodiment described above. In the following description, like reference numerals are used to identify like parts in the first embodiment and will not particularly be described again.

As shown in FIG. 7, the cleaning medium feed mechanism 50 in the fourth embodiment has a discharge nozzle 51 for discharging small pieces of ice as a cleaning medium to the wafer W. This discharge nozzle 51, as in the first embodiment, is disposed at a distal end of an arm 54 driven by a nozzle moving mechanism 52 to swing about a vertical shaft 53. Thus, the discharge nozzle 51 is reciprocable between a position opposed to the center of rotation of the wafer W held by the spin chuck 70, and a position opposed to the edge of the wafer W. The nozzle moving mechanism 52 is constructed for moving the arm 54 vertically also.

The discharge nozzle 51 is connected to an ice source 46 through a solenoid valve 56 and a crushing mixer 45. Ice supplied from the ice source 46 is crushed to small pieces by the crushing mixer 45. The crushed small pieces of ice are transported from the crushing mixer 45 by nitrogen gas supplied thereto as a carrier gas, and jetted from the discharge nozzle 51 to the wafer W. Numeral 55 denotes a tube for transmitting the small pieces of ice.

When the substrate treating apparatus in the fourth embodiment executes the cleaning medium supplying step (Step S3) in FIG. 4, the wafer W is held and rotated at low speed by the spin chuck 70. Driven by the nozzle moving mechanism 52 of the cleaning medium feed mechanism 50, the discharge nozzle 51 moves back and forth between the position opposed to the center of rotation of the wafer W held by the spin chuck 70 and the position opposed to the edge of the wafer W. At this time, the solenoid valve 56 is opened to discharge the small pieces of ice as the cleaning medium from the discharge nozzle 51, with nitrogen gas serving as the carrier gas. Thus, the small pieces of ice are supplied over the entire surface of the wafer W rotating with the spin chuck 70, to clean the surface of wafer W.

In the cleaning medium supplying step executed by the substrate treating apparatus in the fourth embodiment, small pieces of ice, which are solids, are used as the cleaning medium. Where small pieces of ice are used as the cleaning medium, which clean the substrate with physical force, the cleaning capability for organic substances is improved. Residues of the reaction product, swollen in the remover supplying step, may be stripped off efficiently in a short time. Further, by dispensing with the conventional cleaning step with deionized water, the cost of the apparatus may be reduced and the treating process expedited. The size of small pieces of ice in this step, preferably, is several tens of microns.

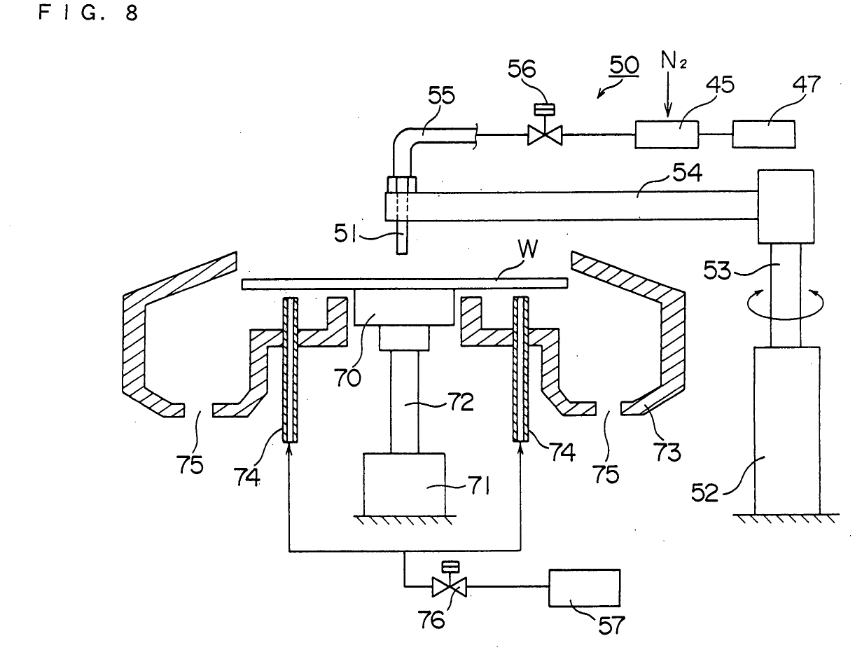

A further embodiment of the invention will be described. FIG. 8 is a schematic side view of a substrate treating apparatus in the fifth embodiment of the invention. As does FIG. 3 described above, FIG. 8 shows a relationship between a cleaning medium feed mechanism 50, a spin chuck 70 and a scatter preventive cup 73. The construction and arrangement of a remover feed mechanism 30 and other components shown in FIGS. 1 and 2 are the same as in the first embodiment.

In the substrate treating apparatus according to the fifth embodiment, small pieces of dry ice (carbon dioxide in solid state) are supplied to the wafer W instead of the warm water in the first embodiment described above. In the following description, like reference numerals are used to identify like parts in the first embodiment and will not particularly be described again.

As shown in FIG. 8, the cleaning medium feed mechanism 50 in the fifth embodiment has a discharge nozzle 51 for discharging small pieces of dry ice as a cleaning medium to the wafer W. This discharge nozzle 51, as in the first embodiment, is disposed at a distal end of an arm 54 driven by a nozzle moving mechanism 52 to swing about a vertical shaft 53. Thus, the discharge nozzle 51 is reciprocable between a position opposed to the center of rotation of the wafer W held by the spin chuck 70, and a position opposed to the edge of the wafer W. The nozzle moving mechanism 52 is constructed for moving the arm 54 vertically also.

The discharge nozzle 51 is connected to a dry ice source 47 through a solenoid valve 56 and a crushing mixer 45 as in the fourth embodiment. Dry ice supplied from the dry ice source 47 is crushed to small pieces by the crushing mixer 45. The crushed small pieces of dry ice are transported from the crushing mixer 45 by nitrogen gas supplied thereto as a carrier gas, and jetted from the discharge nozzle 51 to the wafer W. Numeral 55 denotes a tube for transmitting the small pieces of dry ice.

When the substrate treating apparatus in the fifth embodiment executes the cleaning medium supplying step (Step S3) in FIG. 4, the wafer W is held and rotated at low speed by the spin chuck 70. Driven by the nozzle moving mechanism 52 of the cleaning medium feed mechanism 50, the discharge nozzle 51 moves back and forth between the position opposed to the center of rotation of the wafer W held by the spin chuck 70 and the position opposed to the edge of the wafer W. At this time, the solenoid valve 56 is opened to discharge the small pieces of dry ice as the cleaning medium from the discharge nozzle 51, with nitrogen gas serving as the carrier gas. Thus, the small pieces of dry ice are supplied over the entire surface of the wafer W rotating with the spin chuck 70, to clean the surface of wafer W.

In the cleaning medium supplying step executed by the substrate treating apparatus in the fifth embodiment, small pieces of dry ice, which are solids, are used as the cleaning medium. Where small pieces of dry ice are used as the cleaning medium, which clean the substrate with physical force, the cleaning capability for organic substances is improved. Residues of the reaction product, swollen in the remover supplying step, may be stripped off efficiently in a short time. Further, by dispensing with the conventional cleaning step with deionized water, the cost of the apparatus may be reduced and the treating process expedited. The size of small pieces of dry ice in this step, preferably, is several tens of microns.

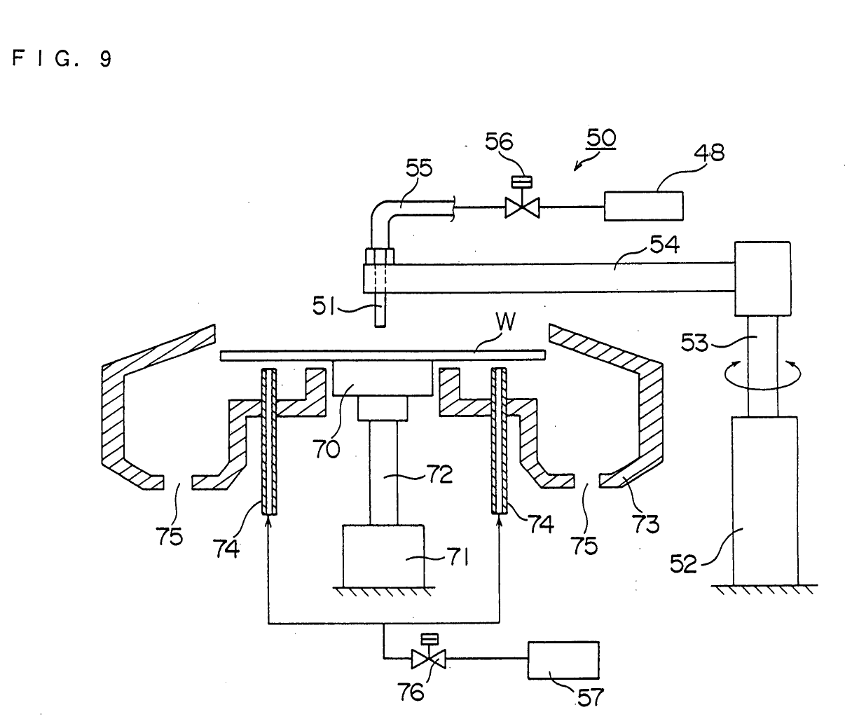

A still further embodiment of the invention will be described next. FIG. 9 is a schematic side view of a substrate treating apparatus in the sixth embodiment of the invention. As does FIG. 3 described above, FIG. 9 shows a relationship between a cleaning medium feed mechanism 50, a spin chuck 70 and a scatter preventive cup 73. The construction and arrangement of a remover feed mechanism 30 and other components shown in FIGS. 1 and 2 are the same as in the first embodiment.

In the substrate treating apparatus according to the sixth embodiment, hydrogen water is supplied to the wafer W instead of the warm water in the first embodiment described above. In the following description, like reference numerals are used to identify like parts in the first embodiment and will not particularly be described again.

As shown in FIG. 9, the cleaning medium feed mechanism 50 in the sixth embodiment has a discharge nozzle 51 for discharging the hydrogen water as a cleaning medium to the wafer W. This discharge nozzle 51, as in the first embodiment, is disposed at a distal end of an arm 54 driven by a nozzle moving mechanism 52 to swing about a vertical shaft 53. Thus, the discharge nozzle 51 is reciprocable between a position opposed to the center of rotation of the wafer W held by the spin chuck 70, and a position opposed to the edge of the wafer W. The nozzle moving mechanism 52 is constructed for moving the arm 54 vertically also.

The discharge nozzle 51 is connected to a hydrogen water source 48 through a solenoid valve 56. Hydrogen water fed from the hydrogen water source 48 is jetted from the discharge nozzle 51 to the wafer W. Numeral 55 denotes a tube for feeding the hydrogen water.

When the substrate treating apparatus in the sixth embodiment executes the cleaning medium supplying step (Step S3) in FIG. 4, the wafer W is held and rotated at low speed by the spin chuck 70. Driven by the nozzle moving mechanism 52 of the cleaning medium feed mechanism 50, the discharge nozzle 51 moves back and forth between the position opposed to the center of rotation of the wafer W held by the spin chuck 70 and the position opposed to the edge of the wafer W. At this time, the solenoid valve 56 is opened to discharge the hydrogen water as the cleaning medium from the discharge nozzle 51. Thus, the hydrogen water is supplied over the entire surface of the wafer W rotating with the spin chuck 70, to clean the surface of wafer W.

In the cleaning medium supplying step executed by the substrate treating apparatus in the sixth embodiment, hydrogen water which is deionized water with an enhanced cleaning capability for removers is used as the cleaning medium. Where hydrogen water with high activating power is used as the cleaning medium, the cleaning capability for organic substances is increased. Residues of the reaction product, swollen in the remover supplying step, may be stripped off efficiently in a short time. Further, by dispensing with the conventional cleaning step with deionized water, the cost of the apparatus may be reduced and the treating process expedited.

The hydrogen water described in this specification is a solution having hydrogen dissolved in water (deionized water).

In the first to sixth embodiments described above, the invention is applied to the substrate treating apparatus for removing a polymer produced during dry etching from the wafer W having undergone the dry etching. However, the invention is not limited to the removal of a polymer produced during dry etching from the wafer W.

For example, the invention is applicable also to removal of a polymer produced during plasma ashing. That is, this invention is applicable also to a substrate treating apparatus for removing polymers produced from resists during various processes other than dry etching.

Further, this invention is not limited to removal of a polymer produced in a treating process such as dry etching or plasma ashing, but also includes removal of various reaction products resulting from resists.

The invention may be applied, for example, to the treatment of a substrate having undergone an impurity diffusion process of parts of the film not covered by a resist film acting as a mask. For example, ion implantation is one of such impurity diffusion processes. A substrate having undergone such a process has ions entering the resist film as well as parts of the film present under but not covered by the resist film. Consequently, the whole or part of the resist changes into what is called in this specification a “reaction product resulting from a change in property of the resist”. Such reaction product also is an organic substance to be removed by the substrate treating apparatus according to this invention.

Further, the invention is not limited to removal of the resist-originated reaction product from the substrate, but includes also a case of removing the resist itself from the substrate.

For example, the invention is applicable to treatment of a substrate coated with a resist, a pattern (e.g. a wiring pattern) exposed on the resist which is then developed, and an lower film process conducted on the lower film present under the resist. The unwanted resist film is removed from the substrate after the lower film process.

More particularly, the invention encompasses a case where, for example, the lower film is etched after development of the resist film. Whether the etching process is wet etching or dry etching such as RIE, the resist film becomes unnecessary and should be removed after the etching process. The substrate treating apparatus according to the invention are intended also for such resist removal following the etching process.

Further, where an impurity diffusion process is conducted as a lower film process after the resist film is developed, the resist film becomes unnecessary and should be removed after the etching process. The substrate treating apparatus according to the invention are intended also for such resist removal.

In these cases, any reaction product resulting from a change in property of the resist film may be removed together with the unwanted resist film. This is advantageous in improving throughput and reducing cost.

In the dry etching process described above, where the lower film is dry-etched, for example, a resist-originated reaction product is also generated. As a result, the resist film itself serving as a mask for the lower film during the dry etching and the reaction product resulting from a change in property of the resist film may be removed at the same time. A resist-originated reaction product is generated also when the impurity diffusion process (ion implantation in particular) is conducted on the lower film. Consequently, the resist film itself serving as a mask for the lower film during the impurity diffusion process and the reaction product resulting from a change in property of the resist film may be removed at the same time.

Furthermore, with the substrate treating apparatus according to this invention, it is possible to remove not only resist-originated reaction products and the resist itself, but also organic matter not originating from the resist, such as minute contaminants emanating from the human body.

In the first to sixth embodiments described above, the organic removing treatment is completed by supplying various cleaning media to the wafer W using the cleaning medium feed mechanism 50 after the remover feed mechanism 30 supplies a remover to the wafer 30. However, deionized water may further be supplied to the wafer W by using the cleaning medium feed mechanism 50 to clean the wafer W again with the deionized water.

The present invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Applications No. 2001-373586 filed in the Japanese Patent Office on Dec. 7, 2001 and No. 2002-305200 filed in the Japanese Patent Office on Oct.21, 2001, the entire disclosure of which is incorporated herein by reference.

1-12. (canceled)

13. A substrate treating method for removing an organic substance from a surface of a substrate, comprising the steps of:
supporting the substrate;
supplying a remover toward a surface of the substrate having said organic substance thereon; and
supplying deionized water with an enhanced remover cleaning capability toward said surface having said remover thereon;
wherein said deionized water with enhanced remover cleaning capability is hydrogen water.

14. A substrate treating method as defined in claim 13, wherein said organic substance is a reaction product resulting from a change in property of a resist.

15. A substrate treating method as defined in claim 14, further comprising the step of performing dry etching on said resist so as to generate said reaction product.

16. A substrate treating method as defined in claim 13, further comprising the step of spinning said substrate after supplying said remover, or after supplying said deionized water, or both.

17. A substrate treating method for removing an organic reaction product resulting from a change in property of a resist from a surface of a substrate, comprising the steps of:
supporting the substrate;
supplying a remover toward a surface of the substrate having said reaction product thereon;
supplying deionized water with an enhanced remover cleaning capability toward said surface having said remover thereon;
wherein said deionized water with enhanced remover cleaning capability is warm deionized water.

18. A substrate treating method as defined in claim 17, further comprising the step of performing dry etching on said resist so as to generate said reaction product.

19. A substrate treating method as defined in claim 17, further comprising the step of spinning said substrate after supplying said remover, or after supplying said deionized water, or both.

20. A substrate treating method for removing an organic reaction product resulting from a change in property of a resist from a surface of a substrate, comprising the steps of:
supporting the substrate;
supplying a remover toward a surface of the substrate having said reaction product thereon; and
supplying a gas toward the surface of the substrate having the remover thereon;
wherein said gas is steam.

21. A substrate treating method as defined in claim 20, further comprising the step of performing dry etching on said resist so as to generate said reaction product.

22. A substrate treating method as defined in claim 20, further comprising the step of spinning said substrate after supplying said remover, or after supplying said deionized water, or both.
